(19) United States
(12) Patent Application Publication
(10) Pub. No.: US 2009/0302497 A1
(43) Pub. Date: Dec. 10, 2009

(54) FLOW RESTRICTOR FOR INJECTION MOULDING MACHINE FOR THE INJECTION MOULDING OF RUBBER MATERIALS OR OF ELASTOMER MATERIALS

(76) Inventors: Rainer Schmidt, Altdorf (DE); Hubert Degenbeck, Postau/Oberkollnbach (DE)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/309,770

(22) PCT Filed: Jul. 31, 2007
(86) PCT No.: PCT/EP2007/006765

§ 371 Date: Jul. 14, 2009

(30) Foreign Application Priority Data
Aug. 1, 2006 (DE) 10 2006 035 816.3

(51) Int. Cl. B29C 71/02; B29C 45/30

(52) U.S. Cl. 264/235; 425/145

(57) ABSTRACT

The present invention relates to a throttle for an injection molding machine for injection molding rubber or elastomeric material and comprises a throttle block, an inlet channel and an outlet channel provided therein as well as a throttle means. The inlet channel can be provided at an angle relative to the outlet channel. The throttle means comprises a throttle piston, which serves both to reduce the material flow and inject the rubber or elastomeric materials into the injection mold. A system and method for tempering rubber or elastomeric material in injection molding can be realised with the throttle of the invention, wherein in particular shorter cycle times can be achieved.

The invention relates to a throttle for an injection molding machine for injection molding rubber or elastomeric materials, an injection molding machine comprising such a throttle, a system for tempering rubber or elastomeric materials during injection molding as well as a corresponding method.

The prior art, e.g., WO 2006/008164 A2 discloses an injection molding machine and an injection molding method for injection molding plastic materials, in particular rubber and elastomeric materials. Said injection molding machine comprises an extruder, a first piston/cylinder unit and a second piston/cylinder unit mounted in series thereto. The cylinder of the first piston/cylinder unit leads into the end of the second piston/cylinder unit located at a distance from an injection mold to be filled. The plastic material is led by means of the first piston/cylinder unit through the cylinder of the second piston/cylinder unit into the injection mold, wherein the piston of the second piston/cylinder unit frees the flow path to the injection mold. Afterwards the piston of the second piston/cylinder unit is moved into the associated cylinder to introduce the plastic material located inside the second cylinder into the injection mold. The two piston/cylinder units of this injection molding machine are preferably essentially vertical and connected to each other by a diverting element. The diverting element may comprise a throttle of variable cross-section which is mechanically adjustable or can be actuated electrically, hydraulically or pneumatically. It is possible to adjust the plastic material to a predetermined target temperature by means of this throttle.

Moreover, DE 199 54 653 B4 and DE 299 23 755 U1 disclose an extruder for the preparation of rubber mixtures for elastomeric products. The extruder comprises a cylinder, a screw rotatably mounted in the cylinder for drawing, conveying and homogenizing the rubber mixture and an extrusion head comprising an inserted extrusion tool. According to one embodiment, the extrusion head of the extruder is provided with a pressure piece designed to further increase the mixing temperature of the rubber mixture in the channel of the screw as well as in the extrusion head by means of adjusting or increasing the pressure and to reduce the mean residence time at higher mixing temperatures.

DE 19 64 895 A, DE 2 002 102 A and CH 512 1978 C relate to devices and methods for processing plastic materials. Here the cold plastic material filled in a cylinder is basically adiabatically compressed without external heat supply via a piston and is only thus heated and pressed out through a narrowed outlet and fused thereby. Fusion of the plastic material is due to the conversion of the compression energy applied with high pressure occurring during pressing the plastic material through a shearing gap of about 0.05 mm as outlet.

Further methods for extruding plastic materials as well as corresponding extruders are described, e.g., in DE 37 37 618 A1, DE 1 529 774 A and U.S. Pat. No. 3,647,344 A.

It is the object of the present invention to provide means considerably improving the processing of rubber or elastomeric materials in injection molding, wherein in particular shorter cycle times and a higher variability regarding the rubber or elastomeric materials to be processed are ensured. This object is achieved with the features of the independent claims. Preferred embodiments are described in the dependent claims.

In order to achieve the above object, it is the basic idea of the invention to ensure tempering of the rubber or elastomeric materials by a throttle provided in the flow path in the injection molding machine. According to an aspect of the present invention, a throttle is provided for an injection molding machine for injection molding rubber or elastomeric materials, which comprises a throttle block, an inlet channel and an outlet channel provided therein as well as a throttle means. The inlet channel leads into the outlet channel at an angle which is preferably higher than 45°, and more preferably higher than 75°. The throttle means comprises a throttle piston serving both to reduce the material flow and to inject the rubber or elastomeric material into an injection mold.

Preferably the throttle means further comprises a throttle area interacting with the throttle piston and tapering conically in flow direction, and comprises an end portion of minimum diameter through which the throttle piston can be led, wherein the throttle is closed if the throttle piston led through the end portion. Moreover or as an alternative, it is preferred to provide the throttle means with a throttle bushing and a throttle bushing insert, wherein the throttle bushing and the throttle bushing insert form an annulus in the port region of the inlet channel in the outlet channel. The cross-section of this annulus increases preferably with increasing distance to the inlet channel. Thus, the supplied rubber or elastomeric material can be distributed as uniformly as possible in the annular gap.

Alternatively, it is also possible to provide the throttle bushing insert with a borehole conically tapering in flow direction so that the rubber or elastomeric material does not flow around the entire periphery of the throttle piston but only a circumferential part thereof, i.e., about 90° of the piston contact the rubber or elastomeric material. Thus, less pollution is ensured when the throttle piston is retracted. Accordingly, in all embodiments the throttle bushing insert forms a throttle area conically tapering in flow direction, which is interacting with the throttle piston.

According to a further aspect of the present invention, a throttle is provided for an injection molding machine for injection molding rubber or elastomeric materials, said throttle comprising a throttle block, an inlet channel and an outlet channel provided therein as well as a throttle means arranged in the outlet channel. The inlet channel leads into the outlet channel. The throttle means comprises a throttle piston and a throttle area interacting with the throttle piston and tapering conically in flow direction, wherein the throttle area has an end portion of minimum diameter or cross-section through which the throttle piston can be led. The throttle is closed if the throttle piston is passed through the end portion.

The throttle means preferably comprises a throttle bushing and a throttle bushing insert, wherein the throttle bushing and the throttle bushing insert form an annulus in the port region of the inlet channel in the outlet channel. Preferably the cross-section of this annulus is at a distance from the inlet channel or opposite the inlet channel greater than in the port region. The throttle bushing insert preferably defines the throttle area tapering conically in flow direction.

According to a further aspect of the present invention, a throttle is provided for an injection molding machine for injection molding rubber or elastomeric materials, the throttle comprising a throttle block, an inlet channel and an outlet channel provided therein as well as a throttle means arranged in the outlet channel. The inlet channel leads into the outlet channel. The throttle means comprises a throttle piston, a throttle bushing and a throttle bushing insert, wherein the throttle bushing and the throttle bushing insert form an annulus in the port region of the inlet channel in the outlet channel.

Preferably said annulus has a cross-section which is increasing with increasing distance to the inlet channel. In the various embodiments the throttle bushing insert is preferably arranged in the throttle bushing. Further, the throttle bushing and the throttle bushing insert are preferably mountable from opposite sides of the throttle block. Also in the above-described embodiment, the throttle bushing insert defines a throttle area tapering conically in flow direction and interacting with the throttle piston.

According to a further aspect, the present invention relates to an injection molding machine for injection molding rubber or elastomeric materials comprising an extruder, a first piston/cylinder unit and a second piston/cylinder unit connected in series thereto as well as a throttle according to the above description. The inlet channel of the throttle is in flow connection with an outlet end of the first piston/cylinder unit and the outlet channel of the throttle is in flow connection with an inlet end of the second piston/cylinder unit. The piston of the second piston/cylinder unit preferably serves as throttle piston and basically entirely empties the cylinder of the second piston/cylinder unit.

Furthermore, the invention relates to a system for tempering rubber or elastomeric materials during injection molding, wherein the system comprises a first piston/cylinder unit comprising a first piston and a first cylinder for supplying the rubber or elastomeric materials into and through a throttle according to the above description and means for adjusting the position of the throttle piston for reducing the material flow in accordance with predetermined parameters for the respective rubber or elastomeric material. Preferably, said system further comprises means for moving the throttle piston through the throttle means in a second cylinder of a second piston/cylinder unit in order to feed the rubber or elastomeric material into an injection mold.

Moreover, according to a further aspect the invention relates to a method for tempering rubber or elastomeric materials during injection molding comprising the steps of supplying the rubber or elastomeric materials via a first piston/cylinder unit comprising a first piston and a first cylinder into and via a throttle according to the above description and for adjusting the throttle piston according to parameters predetermined for the respective rubber or elastomeric material. The method preferably comprises the further step of moving the throttle piston through the throttle means in a second cylinder of a second piston/cylinder unit in order to feed the rubber or elastomeric material into an injection mold.

In the following, preferred embodiments of the invention are exemplarily described with the drawings:

FIG. 1 is a schematic cross-sectional view of a first embodiment of a throttle of the invention when the throttle piston is essentially open;

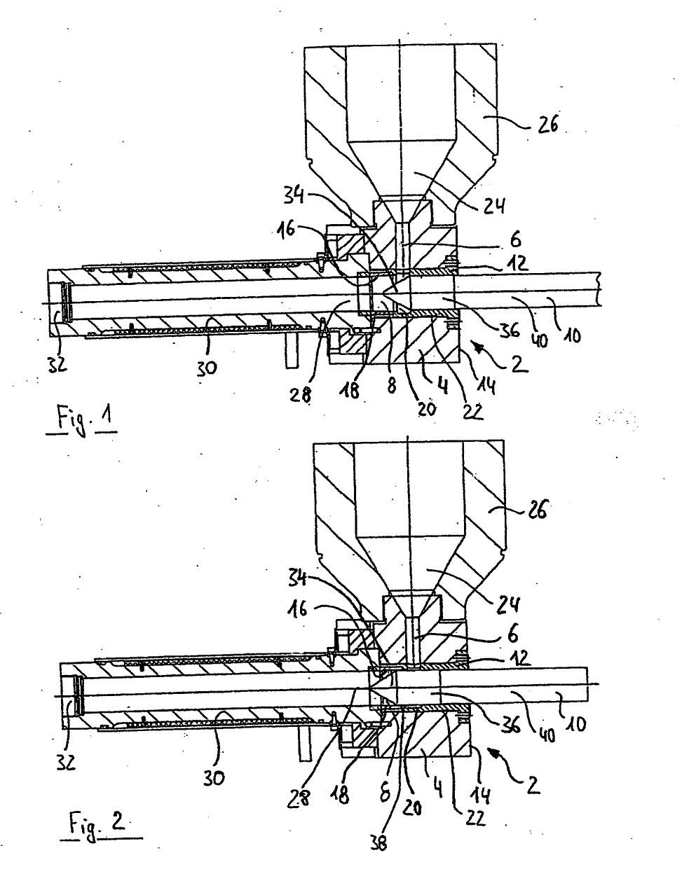

FIG. 2 is a cross-sectional view similar to FIG. 1, wherein the throttle piston is moved in a throttle position for tempering the rubber or elastomeric material;

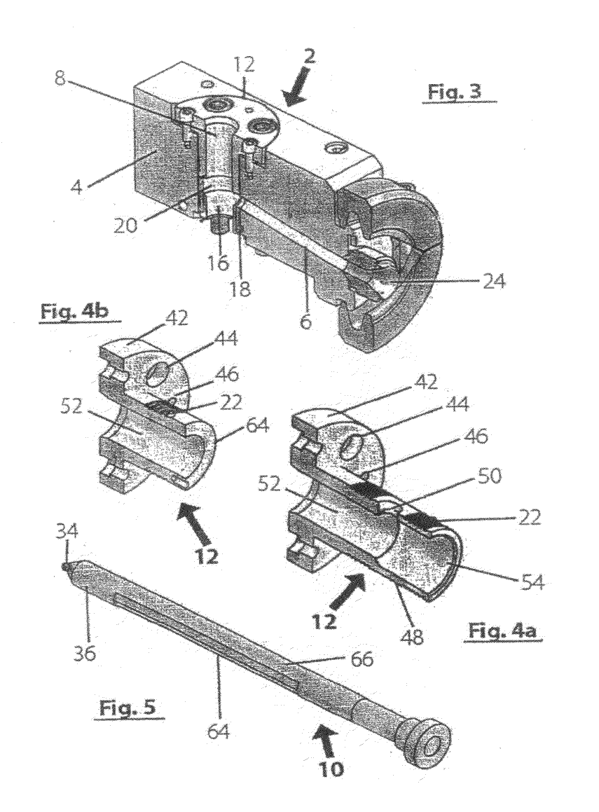

FIG. 3 is a perspective cross-sectional view of an embodiment of a throttle of the invention;

FIG. 4a is a perspective cross-sectional view of a first embodiment of a throttle bushing useable in the throttle of the invention;

FIG. 4b is a perspective cross-sectional view of a further embodiment of a throttle bushing useable in the throttle of the invention;

FIG. 5 is a perspective view of an embodiment of a throttle piston useable in the throttle of the invention;

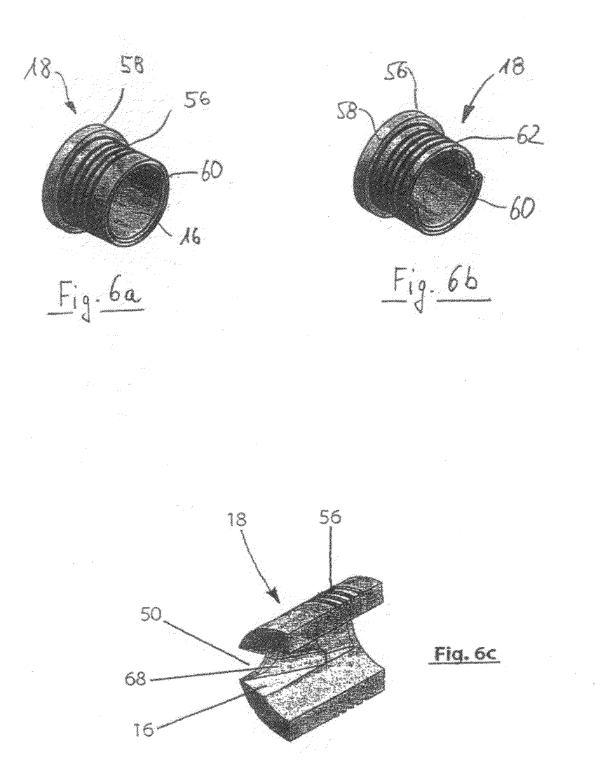

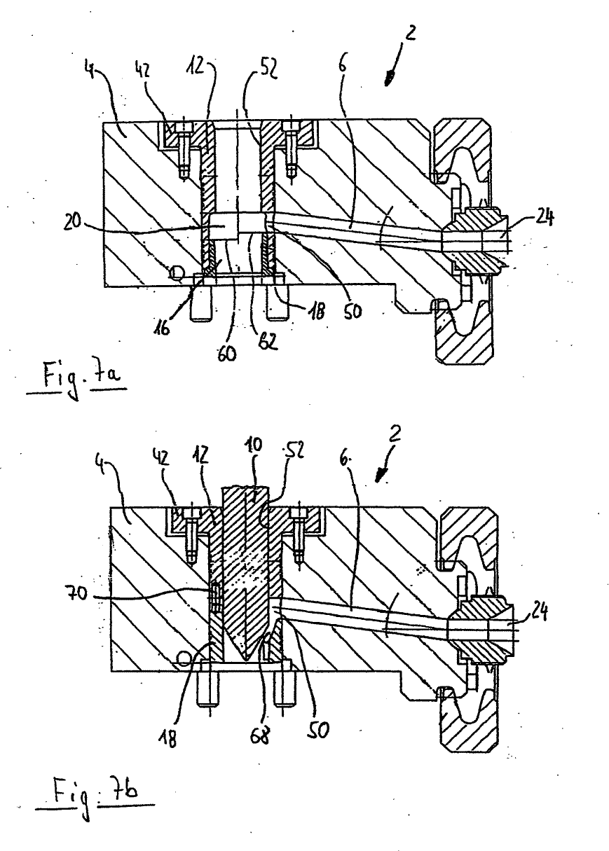

FIG. 6a is a perspective view of a first embodiment of a throttle bushing insert to be used in the throttle of the invention;

FIG. 6b is a view similar to FIG. 6a of a second embodiment of a throttle bushing insert;

FIG. 6c is a perspective view of a third embodiment of a throttle bushing insert;

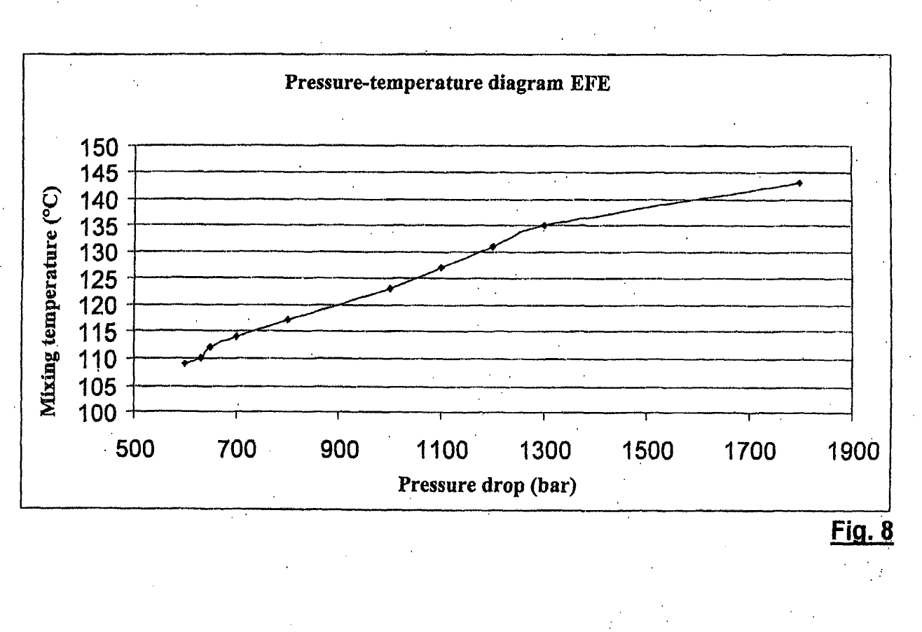

FIG. 7a is a cross-sectional view of a first embodiment of a throttle according to the invention;

FIG. 7b is a cross-sectional view of a second embodiment of a throttle according to the invention;

FIG. 8 is a diagram of the mixing temperature depending on the pressure drop;

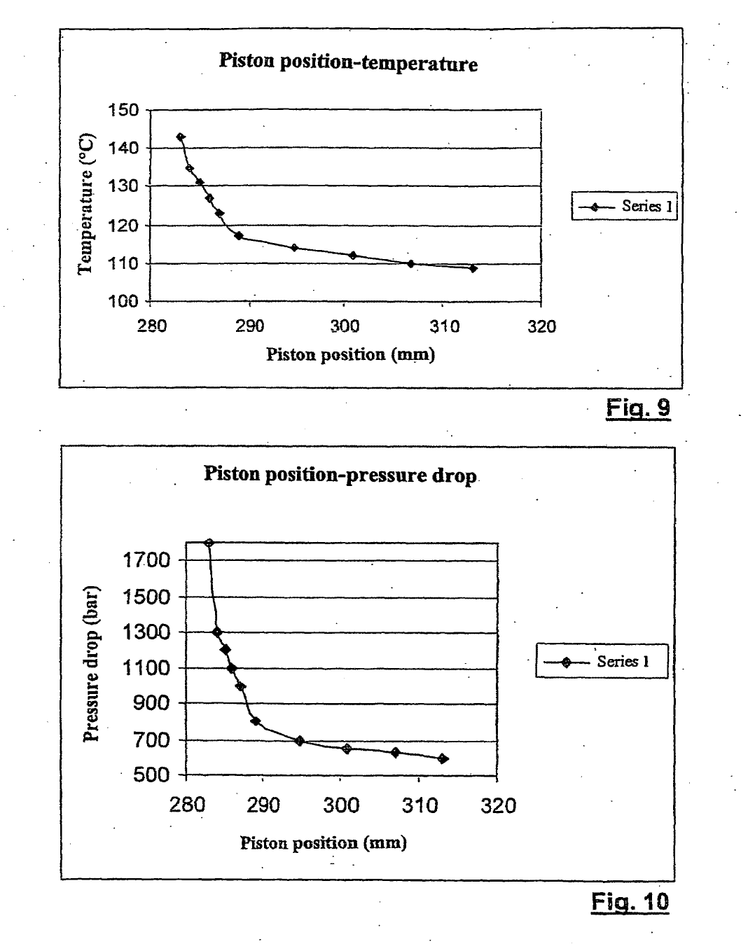

FIG. 9 is a diagram of the temperature depending on the throttle piston position; and

FIG. 10 is a diagram of the pressure drop depending on the throttle piston position.

FIGS. 1 and 2 show a cross-sectional view of a first embodiment of the throttle 2 of the invention. The throttle comprises basically a throttle block 4, an inlet channel 6 and an outlet channel 8 provided therein as well as a throttle means. The inlet channel 6 leads preferably into the outlet channel 8 at an angle greater than 0°, preferably greater than 45°, more preferably greater than 75°. The angle of the embodiment depicted in FIGS. 1 and 2 is about 90° between the inlet channel 6 and the outlet channel 8.

The throttle means is basically arranged in the outlet channel 8 of the throttle block 4 and comprises a throttle piston 10 guided in a throttle bushing 12. The throttle bushing 12 is preferably mounted from a first side surface 14 of the throttle block 4 and screwed therewith. The throttle means further comprises a throttle area 16 which is interacting with the throttle piston 10 and tapering conically in flow direction. In the embodiment shown in FIGS. 1 and 2, said throttle area 16 is formed by a throttle bushing insert 18. The throttle bushing insert 18 is preferably mounted from a side opposite the first surface 14 of the throttle block 4, wherein it is preferred that the throttle bushing insert 18 is arranged in the throttle bushing 12.

The throttle area 16 comprises an end portion having a minimum diameter through which the throttle piston 10 can be led, wherein the throttle is preferably basically closed if the throttle piston 10 is led through the end portion. The throttle bushing 12 and the throttle bushing insert 18 preferably form an annulus 20 in a port region of the inlet channel 6 in the outlet channel 8. This annulus 20 is particularly advantageous for distributing the material supplied through the inlet channel 6 as uniformly as possible in the throttle means. In this context it is preferred to form the annulus 20 asymmetrically, preferably in that the annular section opposing the port region of the inlet channel 6 is greater than the section facing the port region. This is subsequently described in more detail in particular in view of FIGS. 6b and 7a. Moreover, a continuous, progressively or degressively increasing cross-sectional enlargement with increasing distance to the port region is also possible. Such a design enables the material to flow around the throttle piston 10 more easily when flowing into the annular gap, which enables a uniform tempering of the material in the throttle. It is further preferred that all diameter changes in the annulus have substantial radii in order to eliminate possible dead zones where rubber or elastomeric material could deposit.

The use of a throttle means with a throttle bushing 12 and a separate throttle bushing insert 18 is particularly advantageous for reasons of easier producibility, easier mounting and reduced operating costs. Since the throttle area 16 is formed by the throttle bushing insert 18, it can be exchanged separately upon signs of wear, which is considerably cheaper than exchanging an integral throttle bushing with incorporated throttle area. The throttle bushing 12 preferably comprises a labyrinth seal 22 and is thus sealed in the throttle block 4 to prevent leakage of rubber or elastomeric material.

The throttle 2 of the invention is in particular advantageously useable in an injection molding machine comprising two piston/cylinder units as described, e.g., in WO 2006/008164 A2 already mentioned in the introductory portion. Here the throttle 2 of the invention also assumes the function of the diverting element described in this document between a first piston/cylinder unit and a second piston/cylinder unit.

In the embodiment shown in FIGS. 1 and 2 an outlet end 24 of a cylinder 26 of a first piston/cylinder unit of the injection molding machine is coupled to the inlet channel 6 of the throttle block 4. The piston (not shown) of the first piston/cylinder unit conveys the rubber or elastomeric material through the cylinder 26 into the inlet channel 6 of the throttle 2. The outlet channel 8 of the throttle 2 is connected to an inlet end 28 of a second cylinder 30 of a second piston/cylinder unit. An outlet end 32 of the second piston/cylinder unit is adapted to be connected to an injection mold (not shown).

According to the invention the throttle piston 10 of the throttle 2 preferably serves as piston for the second piston/cylinder unit. The throttle piston 10 is formed such that it serves on the one hand to reduce the material flow through the throttle 2 and on the other hand to feed the material from the second cylinder 30 of the second piston/cylinder unit into the injection mold. In this context it is particularly advantageous that the cylinder 30 as well as the outlet channel of the throttle 2 can be basically emptied completely by the throttle piston 10 and rubber or elastomeric material remainders are not left.

In the position shown in FIG. 1 the throttle piston 10 is retracted so far from the inlet channel 8 or the throttle bushing 12 that the material may flow basically unhinderedly or unrestrictedly from the inlet channel 6 into the outlet channel 8 and the second cylinder 30. Here a tip 34 of the throttle piston 10 extends slightly into the area of the annular gap 20 and ends slightly within the throttle bushing insert 18. The tip 34 of the throttle piston 10 has an advantageous effect on diverting the material flow from the inlet channel 6 into the outlet channel 8.

In the position shown in FIG. 2 the throttle piston 10 is further drawn into the throttle 2, wherein a piston skirt 36 is drawn by about one quarter of its length in the throttle bushing insert 18 thus forming an annular gap 38 between the piston skirt 36 and the throttle area 16 of the throttle bushing insert 18 through which the rubber or elastomeric material has to be pressed. Here the material flows through the inlet channel 8 and the annulus 20 of the throttle 2 starting from the outlet end 24 of the first piston/cylinder unit before reaching, through the annular gap 38, the inlet end 28 of the second cylinder 30 of the second piston/cylinder unit. The annular width of the annular gap 38 as well as the throttle length, i.e., the width of the annular gap 38, and thus the throttling effect on the rubber or elastomeric material can be adjusted by positioning the throttle piston 10 in order to create conditions optimally adapted to the respective materials and process requirements. Since the throttle area 16 created by the throttle bushing insert 18 tapers in flow direction of the material flow, the annular gap 38 becomes the smaller the further the piston 10 is inserted in the throttle bushing insert.

The length of the throttle area 16 is preferably between 5 mm and 50 mm, more preferably between 10 mm and 40 mm and most preferably between 20 mm and 30 mm. The tapering of the throttle area 16 is preferably defined by an angle in the range between 0.5° and 5°, more preferably between 1.5° and 3.5° and most preferably between 2° and 3° regarding the rotation axis of the throttle bushing insert 18. The diameter of the throttle bushing insert 18 is preferably in the range between 10 mm and 50 mm, more preferably between 15 mm and 40 mm, even more preferably between 20 mm and 30 mm. The annular gap 20 has preferably a diameter enlarged vis-à-vis the diameter of the piston skirt 36 of the throttle piston 10 by at least 2 mm, more preferably by at least 4 mm and most preferably by at least 6 mm. The width of the annular gap 20 usually corresponds to about the diameter of the inlet channel, e.g., about 10 mm to 15 mm, in particular about 12 mm. In an expanding or expanded cross-section of the annulus 20 at the side opposite the port region, the width of the annulus 20 is preferably at least about 2 mm, preferably at least 4 mm greater than in the port region.

If the throttle piston 10 is retracted basically until the smallest-diameter end portion of the throttle bushing insert 18, the width of the annular gap is basically 0, i.e., the throttle means closes the flow path through the throttle 2 basically completely. When the throttle piston 10 is further moved in the cylinder 30 of the second piston/cylinder unit to feed the rubber or elastomeric material into the injection mold, the opening of the inlet channel 6 is basically closed by the piston so that no material can further flow in. To this end, the throttle piston 10 can be formed over its entire length with the same diameter as in the area of the piston skirt 36. Alternatively, it is preferred to form the throttle piston 10 in an area 40 following the piston skirt 36 with a reduced cross-sectional profile. However, for sealing the port region of the inlet channel 6 it is preferred to not form a first area of the piston extending in longitudinal direction and facing the port region in a diameter-tapered manner, i.e., with a diameter corresponding to the piston skirt 36 and preferably additionally to not form a second area of the piston extending in longitudinal direction and opposing the port region in a diameter-tapered manner. This is subsequently explained in further detail with reference to FIG. 5.

FIG. 3 shows a perspective cross-sectional view of an embodiment of a throttle 2 according to the invention, which corresponds approximately to the embodiment shown in FIGS. 1 and 2. Contrary to the embodiment of the throttle 2 shown in FIGS. 1 and 2, the inlet channel 6 of the throttle 2 according to FIG. 3 is arranged in the throttle block 4 at an angle of about 83° with regard to the outlet channel 8. Apart from that the embodiment shown in FIG. 3 basically corresponds to the embodiment shown in FIGS. 1 and 2.

FIG. 4a shows a first embodiment of a throttle bushing 12 which is mounted in the throttle 2 shown in FIG. 3. The throttle bushing 12 comprises a mounting flange 42 for mounting the throttle bushing 12 at the throttle block 4. Preferably through-holes 44 as well as alignment pin boreholes are provided for mounting. An elongate portion 48 with basically constant outer diameter extends from the flange 42 at which labyrinth seals 22 are provided for sealing the bushing 12 in the throttle block 4. Furthermore, an inlet opening or port opening 50 is provided in the section 48, the opening being snugly arranged with the inlet channel 6 in the throttle block 4 to enable a flow of the material into the throttle bushing 12. In its interior, the throttle bushing 12 has a section 52 of a diameter corresponding approximately to the outer diameter of the throttle piston 10 or the piston skirt 36. This portion 52 is formed for guiding the throttle piston 10 in the throttle bushing 12. In the area of the port opening 50, the inner diameter expands to an area 54 having a larger diameter. In this area 54 of larger diameter the throttle bushing insert 18 is inserted from a side opposite the flange 42. FIGS. 6a and 6a show various throttle bushing inserts 18 useable with the throttle bushing 12 according to FIG. 4a.

In the embodiment of the throttle bushing insert 18 shown in FIG. 6a a labyrinth seal 50 is also provided for sealing between the throttle bushing insert 18 and the inner surface of the area 54 with larger diameter of the throttle bushing 12. Furthermore, the throttle bushing insert 18 comprises a stop flange 58 which defines the insertion length of the throttle bushing insert 18 into the throttle bushing 12. In mounted condition the end 60 of the throttle bushing insert opposing the stop 58 defines the annulus 20 together with the throttle bushing 12. The throttle area 16 tapering in flow direction is formed preferably along the entire inner surface of the throttle bushing insert 18, wherein the diameter tapers in direction of the flange 58.

FIG. 6b shows a second embodiment of the throttle bushing insert 18 corresponding essentially to the embodiment shown in FIG. 6a, wherein, however, the end 60 opposing the flange 58 is stepped in order to define an annulus 20 changing its width in a condition mounted in the throttle bushing 12. Here the throttle bushing insert 18 is arranged such in the throttle bushing 12 that a stepped area 62 is positioned opposite the port opening 50, thus resulting in an annulus 20 enlarged vis-à-vis the port region of the inlet channel 6, which promotes a uniform material distribution in the annulus 20.

As an alternative to the embodiment of the throttle bushing insert 18 shown in FIGS. 6a and 6b, it is also possible to form the end 60 of the throttle bushing insert in a beveled manner regarding its rotation axis creating an annulus 20 expanding continuously from the port region to the opposite side.

The throttle piston 10 is shown in further detail in FIG. 5. According to the depiction in FIG. 5, the throttle piston 10 comprises, as already mentioned, a tip 34 of the piston as well as a piston skirt 36. The diameter of the piston skirt 36 basically corresponds to the inner diameter of the area 52 having a smaller diameter of the throttle bushing 12. Abutting the piston skirt 36, a recess 64 extending in longitudinal direction is provided preferably around a part of the periphery of the piston 10; the recess makes it easier for the piston 10 to be led through the throttle bushing 12 and in particular the cylinder 30 of the second piston/cylinder unit. As already mentioned above, however, a first area 66 of the piston 10 facing the port opening 50 is designed with the same diameter or radius as in the area of the piston skirt 36 so that the port opening 50 is basically closed when the throttle piston 10 is advanced. Preferably a second area 66 of the piston 10 facing away from the port opening 50 is formed with the same diameter or radius as in the area of the piston skirt 36 so that the piston is guided in the cylinder on both sides.

FIG. 7a shows the above-described embodiment of the throttle 2 in mounted condition. Here in particular the stepped annulus 20 is clearly recognisable, which is provided by the mounting of the throttle bushing 12 from one side of the throttle block 4 and the mounting of the throttle bushing insert 18 from the opposite side of the throttle block 4.

As already described above, the width of the annulus 20 in the area of the port opening 50 corresponds basically to the diameter of the port opening, wherein the width of the annulus 20 increases in an area at a distance to the opening 50. This may take place step-by-step or continuously. In the embodiment shown in FIG. 7a the annular width is formed by the stepped end 60 of the throttle bushing insert 18.

FIG. 4b shows a further embodiment of a throttle 12, which likewise comprises a flange 42 as well as a cylinder portion 52 extending away therefrom to receive the throttle piston 10. Moreover, the mounting openings 44 and the alignment pin opening 46 and the labyrinth seal 22 are provided. As essential difference to the throttle bushing 12 according to FIG. 4a it is noticeable that the cylindrical portion 52 is considerably shorter, i.e., with such a length that a face surface 64 of the throttle bushing 12 ends in the port region of the inlet channel 6. This is clearly shown in FIG. 7b which depicts said embodiment of the throttle 2 of the invention in mounted state.

FIG. 6c shows an embodiment of a throttle bushing insert 18 combinable with this throttle bushing 12. In this embodiment the throttle piston is not annularly surrounded by material flows but the material flow takes only place at one side of the piston around a part of the periphery of the piston. To this end in the throttle bushing insert 18 the throttle area 16 is designed in the form of a slot 68 beveled with regard to the longitudinal axis. Said slot 68 extends along the longitudinal axis of the throttle bushing insert 18 at an angle of preferably about between 15° and 25° and more preferably 18° to 20°. According to this embodiment of the throttle 2 the port opening 50 is provided for the material inflow from the inlet channel 60 in the throttle bushing insert 18. Starting from the port opening 50 the slot 68 extends such at an angle that a tapering channel extends in flow direction. Preferably the slot 68 is provided around a peripheral area of about 10% to 40%, more preferably 15 to 30% of the complete periphery in the throttle bushing insert 18.

It is obvious from the mounted embodiment of this throttle 2 shown in FIG. 7b that the throttle bushing 12 is positioned in appropriate alignment with the throttle bushing insert 18 by an alignment pin 70 so that the port opening 50 of the throttle bushing insert 18 is aligned with the inlet channel 6. In the position of the throttle piston 10 shown in FIG. 7b a flow path for the inflowing material is defined by the throttle piston 10 and the throttle bushing insert 18, in particular the slot 68 provided therein, wherein the flow path is wider or becomes narrower depending on the positioning of the throttle piston 10. Said embodiment is advantageous in particular with regard to the reduced pollution when the throttle piston 10 is retracted after the injection of the rubber or elastomeric material into the injection mold.

The design of the throttle according to the invention enables the realisation of short cycle times for injection molding of various rubber or elastomeric materials and the adjustment of the respectively desired various temperatures in the material by appropriately positioning the throttle piston.

### EXAMPLE

The effect of an injection molding machine provided with a throttle 2 of the invention on the rubber or elastomeric material is subsequently exemplarily described by referring to FIGS. 8 to 10. The injection molding machine used in this example corresponds in its basic structure to the injection molding machine shown in FIGS. 1 and 2. The throttle bushing 12 corresponds to the embodiment shown in FIG. 4b. The throttle piston 10 and the throttle bushing insert 18 correspond to the embodiments shown in FIG. 5 or 6c. As material a strip having a cross-section of 8 mm×25 mm and consisting of a mixture of ethylene-propylene-dien-rubber with a Shore-hardness of 70 (EPDM 70 Shore) has been processed.

FIG. 8 displays the mixing temperature of the EPDM depending on the pressure drop at the piston of the first piston/cylinder unit. In other words FIG. 8 shows the behaviour of the mixing temperature when the flow resistance through the throttle 2 increases, i.e., when the throttle cross-section gets smaller.

Table 1 reveals in the following the data forming the basis for the diagram according to FIG. 8. Here the resistance or pressure drop is indicated as pressure required to inject the material from the first cylinder 26 of the first piston/cylinder unit through the throttle 2, the second cylinder 30 of the second piston/cylinder unit and a nozzle (not shown). To this end, the piston of the first piston/cylinder unit has been moved at a velocity of 100 cm³/s into the cylinder 26. The respective throttle piston position is indicated in millimeters in form of the remaining travel path in the second cylinder 30. At a piston position of 313 mm the throttle is basically completely open as is approximately shown in FIG. 1. At a piston position of about 280 mm the throttle would be basically completely closed; the remaining 280 mm travel path serve to output the material from the second cylinder 30. The throttle 2 is partly open between 313 mm and 280 mm.

TABLE 1

| Velocity piston | Velocity | Piston | Required | Mass |
|---|---|---|---|---|
| first piston/cylinder | throttle piston | position | pressure | temperature |
| unit in ccm/s | in ccm/s | in mm | in bar | in ° C. |
| 100 | 60 | 313 | ~600 | 109 |
| 100 | 60 | 307 | ~630 | 110 |
| 100 | 60 | 301 | ~650 | 112 |
| 100 | 60 | 295 | ~700 | 114 |
| 100 | 60 | 289 | ~800 | 117 |
| 100 | 60 | 287 | ~1000 | 123 |
| 100 | 60 | 286 | ~1100 | 127 |
| 100 | 60 | 285 | ~1200 | 131 |
| 100 | 60 | 284 | ~1300 | 135 |
| 100 | 60 | 283 | ~1800 | 143 |

The diagrams according to FIGS. 9 and 10 reveal that with increasing closing of the throttle, i.e., reducing passage cross-section through the throttle the required pressure at the first piston of the first piston/cylinder unit increases considerably, which involves an increase in temperature of the elastomeric or rubber material. The temperature of the material has been measured with a penetration probe.

1. A throttle (2) for an injection molding machine for injection molding rubber or elastomeric materials, comprising a throttle block (4), an inlet channel (6) and an outlet channel (8) provided therein, wherein the inlet channel leads into the outlet channel at an angle, and a throttle means comprising a throttle piston (10), wherein the throttle piston serves to reduce the material flow and to inject the rubber or elastomeric material into an injection mold.

2. The throttle according to claim 1, wherein the angle is greater than 45°, preferably greater than 75°.

3. The throttle according to claim 1, wherein the throttle means comprises a throttle area (16) interacting with the throttle piston (10) and tapering conically in flow direction, wherein the throttle area comprises an end portion having minimum diameter through which the throttle piston (10) can be led, wherein the throttle (2) is closed when the throttle piston is led through the end portion.

4. The throttle according to claim 1, wherein the throttle means comprises a throttle bushing (12) and a throttle bushing insert (18), wherein the throttle bushing and the throttle bushing insert form an annulus (20) in the port region of the inlet channel (6) in the outlet channel (8), wherein preferably a cross-section of the annulus (20) increases with a distance from the inlet channel (6).

5. The throttle according to claim 4, wherein the throttle bushing insert (18) defines a throttle area (16) conically tapering in flow direction, which interacts with the throttle piston (10).

6. A throttle (2) for an injection molding machine for injection molding rubber or elastomeric materials, comprising a throttle block (4), an inlet channel (6) and an outlet channel (8) provided therein, wherein the inlet channel leads into the outlet channel, and a throttle means arranged in the outlet channel, wherein the throttle means comprises a throttle piston (10) and a throttle area (16) interacting with the throttle piston and tapering conically in flow direction, wherein the throttle area comprises an end portion having minimum diameter through which the throttle piston (10) can be led, wherein the throttle (2) is closed when the throttle piston is led through the end portion.

7. The throttle according to claim 6, wherein the throttle means comprises a throttle bushing (12) and a throttle bushing insert (18), wherein the throttle bushing and the throttle bushing insert form an annulus (20) in the port region of the inlet channel (6) in the outlet channel (8), wherein preferably a cross-section of the annulus (20) increases with a distance to the inlet channel (6).

8. The throttle according to claim 7, wherein the throttle bushing insert (18) defines the throttle area (16) conically tapering in flow direction.

9. A throttle (2) for an injection molding machine for injection molding rubber or elastomeric materials, comprising a throttle block (4), an inlet channel (6) and outlet channel (8) provided therein, wherein the inlet channel leads into the outlet channel, and a throttle means arranged in the outlet channel, wherein the throttle means comprises a throttle piston (10), a throttle bushing (12) and a throttle bushing insert (18), wherein the throttle bushing and the throttle bushing insert form an annulus (20) in the port region of the inlet channel (6) in the outlet channel (8), wherein preferably a cross-section of the annulus (20) increases with a distance to the inlet channel (6).

10. The throttle according to claim 4, wherein the throttle bushing insert (18) is arranged in the throttle bushing (12).

11. The throttle according to claim 4, wherein the throttle bushing (12) and the throttle bushing insert (18) are mountable from opposite sides of the throttle block (4).

12. The throttle according to claim 9, wherein the throttle bushing insert (18) defines a throttle area (16) tapering conically in flow direction and interacting with the throttle piston (10).

13. The injection molding machine for injection molding rubber or elastomeric materials comprising an extruder, a first piston/cylinder unit and a second piston/cylinder unit connected in series thereto and a throttle (2) according to claim 1, wherein the inlet channel (6) of the throttle is in flow connection with an outlet end (24) of the first piston/cylinder unit and the outlet channel of the throttle with an inlet end (28) of the second piston/cylinder unit.

14. The injection molding machine according to claim 13, wherein the piston of the second piston/cylinder unit serves as throttle piston (10) and basically completely empties the cylinder (30) of the second piston/cylinder unit.

15. A system for tempering rubber or elastomeric materials during injection molding, comprising:
(a) a first piston/cylinder unit comprising a first piston and a first cylinder (26) for supplying the rubber or elastomeric material in and through a throttle (2) according to claim 1; and
(b) means for adjusting the position of the throttle piston (10) for reducing the material flow according to the parameters predetermined for the respective rubber or elastomeric material.

16. The system according to claim 15, comprising:
(c) means for moving the throttle piston (10) through the throttle means in a second cylinder (30) of a second piston/cylinder unit to feed the rubber or elastomeric material into an injection mold.

17. A method for tempering rubber or elastomeric materials during injection molding, comprising the steps:
(a) supplying the rubber or elastomeric material by means of a first piston/cylinder unit comprising a first piston and a first cylinder (26) in and through a throttle (2) according to claim 1; and
(b) adjusting the throttle piston (10) according to parameters predetermined for the respective rubber or elastomeric material.

18. The method according to claim 17 comprising the step:
(c) moving the throttle piston (10) through the throttle means in a second cylinder (30) of a second piston/cylinder unit to feed the rubber or elastomeric material into an injection mold.
